(19) United States
(12) Patent Application Publication
(10) Pub. No.: US 2018/0340311 A1
(43) Pub. Date: Nov. 29, 2018

(54) Composite Manhole Frame with Electronic Identification

(71) Applicant: Composite Access Products GP, LLC, McAllen, TX (US)

(72) Inventor: William C. Nunnery, Mission, TX (US)

(21) Appl. No.: 16/047,104

(22) Filed: Jul. 27, 2018

Related U.S. Application Data
(63) Continuation-in-part of application No. 15/820,595, filed on Nov. 22, 2017.
Application No. 15/820,595 is a continuation-in-part of application No. 62/432,941, filed on Dec. 12, 2016.

(51) Int. Cl. E02D 27/14; H04W 4/80

(52) U.S. Cl. CPC E02D 27/14; H04W 4/80

(57) ABSTRACT

A composite manhole frame has a body that is made of composite material having electronic and/or mechanical components molded into the composite manhole frame. In some embodiments, the electronic components include a radio frequency identification device (RFID). In some embodiments, the electronic components includes sensors. In some embodiments, the electronic and/or mechanical components include switches, locks, and/or indicators.

### CROSS-REFERENCE TO RELATED APPLICATION

This application is a continuation-in-part of U.S. patent application Ser. No. 15/820,595, filed Nov. 22, 2017, which is a continuation of U.S. Provisional Application Ser. No. 62/432,941, filed Dec. 12, 2016.

### FIELD

This invention relates to the field of underground utility access and more particularly to a composite manhole frame with molded-in electronic components.

### BACKGROUND

Underground utility systems are used in cities across the world for infrastructure and maintenance. In order to do their job, municipal workers must enter the underground system in various locations across a city. Workers access these systems via manholes that are sealed with manhole covers. Manhole covers are often made of cast metals.

Many problems arise with the heavy, metal manhole covers. First, they are difficult and dangerous to lift and maneuver. Second, the manholes are a target for thieves that aim to salvage the metal for recycled scrap value. Third, gases produced in wastewater corrode the metal covers and frames weakening them or fusing them shut. Fourth, in some areas metal conducts extremely hot temperatures from steam transmission that burn pedestrians and their pets. Finally, a metal manhole cover can be lethal if a gas explosion launches the metal cover off of the manhole.

Another aspect of underground utility access systems is tracking, storing, and maintaining pertinent information about the systems. Useful information may include date of access, installation date, sewer depth, GPS location of manhole covers, manufacturing date, sewage flow rates, etc. A manhole cover including an electronic component allows municipal workers to track point-of-use information.

However, attaching the electronic component by fastening or adhering mechanically or chemically to the metal manhole cover degrades the properties of such. Fastening and/or adhering mechanically require machining or abrading the surface of the metal manhole cover. Boring and drilling holes into metal manhole covers/components reduce structural strength and provides further surface area for increased oxidation and weakening of the component. Molding or inserting electronic components into metal manhole covers will not function properly because of the metal interferes with radio signals emitted from the electronic components.

What is needed is a manhole frame with in-molded electronic components that can store and communicate important information for municipal workers.

### SUMMARY

The disclosed invention encapsulates an electronic component or components into a manhole frame using composite molding processes. The electronic component(s) communicate data that municipal workers will use to identify, track, and maintain such assets.

Producing a manhole frame using the disclosed materials and processes allows for electronic and mechanical components to be molded within the manhole frame instead of externally attached to the manhole cover as was done in the past. This reduces potential impact damage to the electronic component caused by snowplows, street sweepers, or other mechanical strikes; provides protection of the electronic components from chemical damage caused by sewer gases such as hydrogen sulfide; provides protection of the electronic components from weather elements such as ultraviolet light, rain, snow, and salt; and reduces incentives for theft. A lighter weight manhole cover reduces incidental damage caused by handling of the manhole cover or shocks caused by conduction with underground power lines. Further, such manhole covers enable radio frequency permeation and are more resilient to both high and low temperatures.

In one embodiment, a composite manhole frame is disclosed including a frame body made of a polymer and an electronic device having a transmitter. The electronic device is embedded within the frame such that information from the transmitter of the electronic device is readable through the frame.

In another embodiment, a composite manhole frame is disclosed including a frame formed of a polymer and at least one electronic component. The at least one electronic component placed within the polymer prior to curing of the polymer.

In another embodiment, a composite polymer manhole frame is disclosed including a frame body having a processor embedded there within and at least one sensor that is electrically interfaced to the processor for reading data from the at least one sensor. A transmitter is also embedded within the frame body. The transmitter is electrically interfaced to the processor for transmitting the data to a remote device.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of the composite manhole frame with in-molded electronic component.

FIG. 2 illustrates a cross-sectional view of the composite manhole cover with an in-molded electronic component.

FIG. 3 illustrates an example of the in-molded electronic component.

FIG. 4 illustrates a second example of the in-molded electronic component.

FIG. 5 illustrates a plan view of a composite manhole frame with the in-molded electronic component.

FIG. 6 illustrates a cross-sectional view of the composite manhole frame with the in-molded electronic component.

FIG. 7 illustrates a second plan view of the composite manhole frame with the in-molded electronic component.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

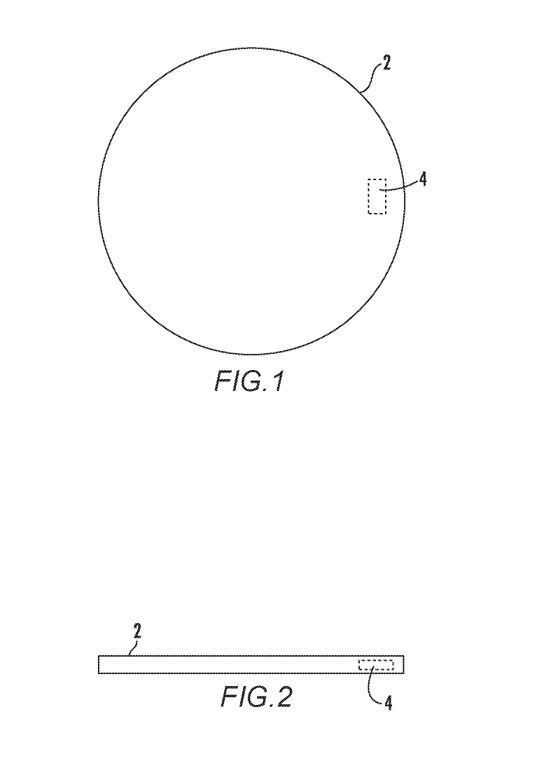

FIG. 1 shows a plan view of a composite manhole cover 2 having molded in electronic/mechanical components 4. FIG. 2 shows a cross-sectional view of the composite manhole cover 2 having molded in electronic/mechanical components 4. Note that the location of the electronic/mechanical components 4 is show as an example and it is fully anticipated that the electronic/mechanical components 4 be located at any location within the composite manhole cover 2, including near or on any surface of the composite manhole cover 2.

Although any use is anticipated for the electronic/mechanical components 4, in one embodiment, the electronic/mechanical components 4 provide point-of-use information to municipal workers. Point-of-use information will eliminate wasted time searching through archives and travelling away from the asset to administrative offices. Storing point-of-use information will also reduce the frequency with which municipal workers need to open the composite manhole cover 2 to verify information about the underground utility system, thereby decreasing the chance of a workplace injury.

In some embodiments, identifying, tracking, and maintaining the assets and information is done with a central computer. In other embodiments, identifying, tracking, and maintaining the information is done with a handheld device. There is no restriction on the type of device or proximity range of the device used to read/write information to/from the electronic/mechanical components 4.

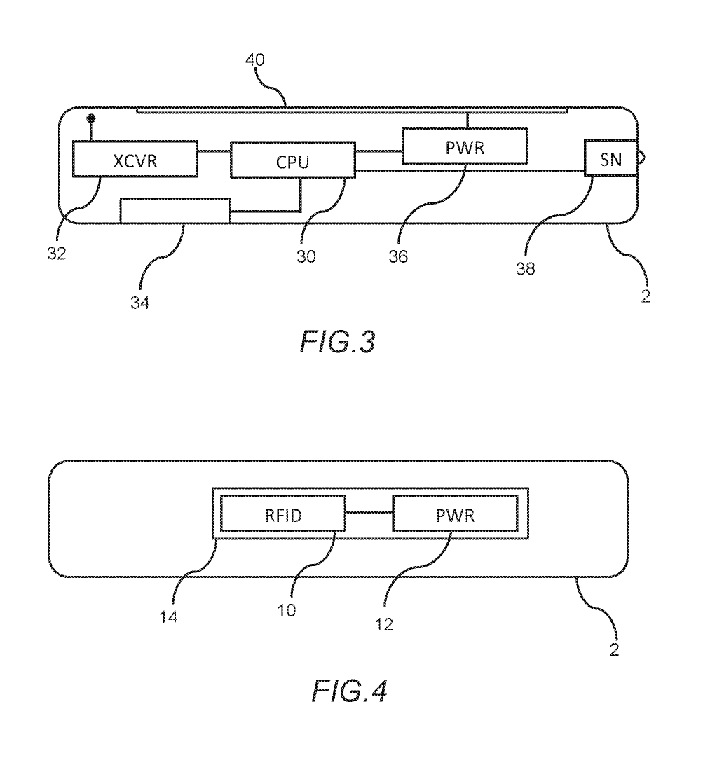

Referring to FIG. 3, one exemplary electronic/mechanical component 4 is shown molded in the composite manhole cover 2. In this example, a processor 30 (e.g., programmable interrupt controller—PIC, controller, any processing element, discrete components for controlling) receives inputs from one or more sensors 34/38. Examples of such sensors 34/38 include, but are not limited to, gas sensors, light sensors, fluid depth sensors, and moisture sensors, tamper sensors 38. The processor 30 receives input data from the sensors 34/38. The data is processed and/or stored within a memory of the processor 30. When needed, or continuously, the data (or processed data) is emitted from of the composite manhole cover 2, in this example, through a transceiver 32, though a transmitter is also anticipated. The transceiver 32 sends the data to an external receiver over radio waves or light waves. In some embodiments, due to power restrictions resulting in limited range of transmission, the external receiver must be near the composite manhole cover 2 while in other embodiments, the receiver is located at a greater distance and communicates with many composite manhole covers 2. In some embodiments, the transceiver 32 is only a transmitter, periodically transmitting information but not receiving information/control back. In some embodiments, the transceiver 32 includes receiving capabilities for reasons including configuration management, control, and acknowledgement.

Power is provide to the processor 30, sensors 34/38, and transceiver 32 by a power subsystem 36 that includes a device for power storage (e.g., a battery, super capacitor) and, in some embodiments, includes a solar collector 40 that is used to recharge the device for power storage.

In one exemplary usage scenario, back flow of sewage in sanitary system is detected by the sensor 34 and relayed to the processor 30 in the composite manhole cover 2 before the fluid level reaches the street. Another exemplary usage scenario includes detecting when a composite manhole cover 2 is opened by a tamper sensor 38 (e.g., a micro switch) so that steps can be taken to understand why one has accessed the manhole without authorization. Another example is using a sensor 34 to measure a gas concentration level inside the sewer, perhaps preventing accidental death from fatal exposures to hydrogen sulfide gas.

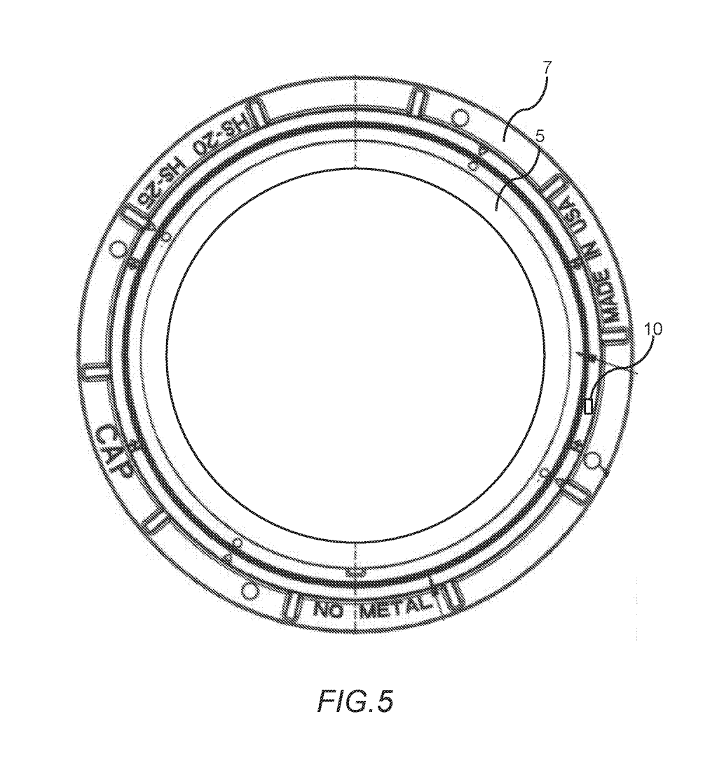

Referring to FIG. 4, an embodiment in which the electronic/mechanical component a radio frequency identification device (RFID) 10 is shown. RFIDs 10 are typically either active (powered by a power source 12 such as a battery) or passive (powered by the electromagnetic energy transmitted from an RFID reader). An RFID 10 sends information to reader device, typically only after being prompted for that information by the reader device.

In some embodiments, the RFIDs include a factory programmed identification value that uniquely identifies each particular RFID 10.

In some embodiments, the RFID 10 is coated with a polymer insulator 14 that protects the RFID 10 and other components from abrasion, high pressure, and high temperatures that are present during the composite molding process. The polymer insulator 14 coats electronic/mechanical components 4 before insertion into the composite manhole cover 2. Examples of materials used for the polymer insulator 14 include, but are not limited to, unsaturated polyester, vinyl ester, epoxy, or a blend of these, with a compatible monomer to dissolve the polymer in solution. Compatible monomers include, but are not limited to, styrene, vinyl toluene, diallyl phthalate, and bisphenol A.

In some embodiments, the RFID 10 requires no power source 12, utilizing radio frequency energy emitted by an RFID reader (not shown for brevity reasons). In some embodiments, the RFID requires power from a power source 12 (e.g., a battery, super capacitor) and, in some embodiments, includes a solar collector 40 as in FIG. 3 that is used to recharge the power source 12.

Methods of making a composite manhole cover 2 include glass fiber reinforced plastic (GFRP) techniques like polymer concrete, cast polymer, resin transfer molding, resin infusion, filament winding, gun chopped fiberglass and resin that is applied directly by an applicator, a brush, roller, hand spreader, or sprayer—often referred to as spray-up layup.

Newer, high volume methods called sheet molding compounds (SMC), thick molding compounds (TMC), and bulk molding compounds (BMC) have been used to mold composites in less time than GFRP methods.

The composite manhole cover 2 is made of a fiber reinforced thermosetting resin compound. Examples of thermosetting resin compounds include: polyester resin, polyurethanes, phenol-formaldehyde resins, urea-formaldehyde, benzoxazines, epoxy resin, diallyl-phthalate, polyimides, furan, silicone, and vinyl ester. Before the compound has set and formed the composite manhole cover 2, a composite mixture is prepared. The composite mixture is made with three major components: resins, fibers, and fillers. The three major ingredients account for ninety to ninety-five percent of the composite by weight. The remaining five to ten percent includes mold release agents, chemical initiators, pigments, thickeners, shrink control additives, and inhibitors.

Resins are supplied in a liquid form so that the fibers, fillers, and other additives blend in a homogeneous way. Resins are made with unsaturated polyesters, vinyl esters, epoxies, and blends of these.

In embodiments using glass fiber reinforcements, glass fibers are made from a low-alkali borosilicate glass formulation known as “E glass.” E glass is melted and blended then cooled and solidified. The solid glass forms strands of fiber that are collected in spools. These spools are used to form various weaves, chopped strands, mats, rovings, ropes, or other presentations. All presentations of the glass fiber give the composite manhole cover 2 stronger mechanical properties and are selected based on geometry and end-use application.

Fillers are added to the composite mixture to reduce cost, increase the viscosity, and give the composite manhole cover 2 properties such as flame retardance, corrosion resistance, increased density, low shrinkage, hardness, and electrical properties. Fillers are inorganic minerals. Suitable fillers include calcium carbonate, aluminum trihydrate, clay, calcium sulfate, barium sulfate, and silicates. These fillers are formed by milling, grinding, and/or precipitating the minerals into particles and separating the particles into a range of sizes. Suitable filler particle sizes range from one micron to one hundred microns.

Mold release agents are added to the composite mixture to ensure that the composite manhole cover 2 does not stick to the mold surface after curing. In some embodiments, the mold release agents are fatty acids. Exemplary fatty acids include calcium stearates, zinc stearates, and magnesium stearates. In other embodiments, alkyl phosphates are used.

Initiators are added to the composite mixture to start the chemical reaction resulting in cross-linking of the resins. In some embodiments, initiators are organic peroxides like diacyl peroxides, peroxy esters, diperoxy ketals, dialkyl peroxides. Some organic peroxides are activated with heat and pressure while some organic peroxides are activated with photo initiators.

Optionally, it is desirable to change the color or provide ultraviolet resistance for the composite manhole cover 2. In some embodiments, pigments are added to the composite mixture to create colors and impart ultraviolet resistance. An exemplary pigment is carbon black.

Thickeners are used to increase the viscosity of the composite mixture. Exemplary thickeners are calcium oxide, calcium hydroxide, magnesium oxide, magnesium hydroxide, fused silica, and water.

In some embodiments, shrink control additives are included in the composite mixture. Shrink control additives reduce the contraction of the composite mixture during the curing process. This is accomplished with thermoplastic additives like polyethylene, polystyrene, polyvinyl chloride, cellulose acetate and butyrate, polycaprolactone, polyvinyl acetate, polymethyl methacrylate, and thermoplastic polyesters.

In some embodiments, inhibitors are included to prevent premature curing. Suitable inhibitors include hydroquinone, parabenzoquinone, tertiary butyl catechol, tertiary butyl hydroquinone, and 2,6-ditertiary butyl-4-methyl phenol.

Now turning to a discussion of preparing the composite mixture for production of the composite manhole cover 2.

First, the liquid and small volume additive constituents (e.g. resins, initiators, inhibitors, pigments, shrink control agents) are blended in a high shear, high speed dispersions to create a homogenous liquid slurry.

Next, in embodiments using the BMC method, the liquid slurry is blended with the fibers and fillers in a low shear mixer. In embodiments using the SMC or TMC method, the liquid slurry is added directly to the other ingredients and blended with rollers that squeeze the materials together.

The composite mixture is inserted into the mold manually, robotically, by a gravity system, by a vacuum pull, by a pump, or with a pneumatic sprayer.

In some embodiments, a higher strength rating is required (e.g. airport runways). In these embodiments, an extra reinforcement of fiber glass roving, pultrusion, glass prepregs, or other higher strength support may be placed in the cavity of the mold before adding the composite mixture.

Next, the electronic/mechanical components 4 are added to the composite mixture.

After the composite mixture and any electronic/mechanical components 4 are in the mold, curing is initiated. Depending on the embodiment, the electronic or mechanical components that are added to the mold optionally include RFID 10, power source 12, processor 30, transceiver 32, sensors 34/38, power subsystem 36, and solar collector 40.

In some embodiments, the composite mixture is cured under high temperature and pressure (approximately 270 to 350 degrees Fahrenheit and 500 to 1500 pounds per square inch). In other embodiments, the composite mixture is cured at ambient temperature and pressure.

After curing is complete, the composite manhole cover 2 is extracted from the mold cavity. The end product is a composite manhole cover 2, optionally including electronic components and/or mechanical components (electronic/mechanical components 4).

Being held within a composite material that does not significantly impact radio frequency transmission, the electronic/mechanical components 4 (e.g. transceiver 32, RFID 10) readily communicate with external devices electronic/mechanical components 4 (not shown for brevity reasons). In some embodiments, this communication includes, but is not limited to, information such as serial number, GPS location, manufacturing date, installation date, inspection date, sewer depth, flow direction, connections, inlets, drop pipes, lift stations, offsets, riser rings, cone type, manhole wall material, installer, inspector, processing station identification, maintenance date, photographs, and other pertinent information to the municipality or owner.

In some embodiments, the RFIDs 10 have user memory. It is anticipated that in some embodiments, the data will be transferred and stored on an external device and/or downloaded to a remote computer. Some examples of data stored in the user memory will be predetermined while some types of data will be determined by the municipality or owner of the composite manhole cover 2. In addition to static identification data, the system will allow entry of variable data inputs, for example current condition of the manhole and composite manhole cover 2, sewer effluent levels and other observations and measurements recorded during a scheduled preventive maintenance review, programmed register, or corrective/containment action.

Municipalities also invest in Capital Asset Tracking (CAT) and/or geographic information system or (GIS) software that maps the location and topography of the municipal assets throughout the city. Information gathered by the electronic/mechanical components 4 is uploaded onto current CAT/GIS software platforms (eg. Arc Gis, Cityworks, Cartograf) in a “.xml” file format so that cities can have up to date condition and status reports on these specific assets stored on their current computer system.

In some embodiments, the composite manhole cover is installed with a composite manhole frame 7. The composite manhole frame 7 is made, for example, using the same process as described above for the composite manhole cover 2. The composite manhole frame 7 is typically installed in an opening of a street atop a riser (not shown for brevity reasons), though there is no restriction as to how the composite manhole frame 7 be installed.

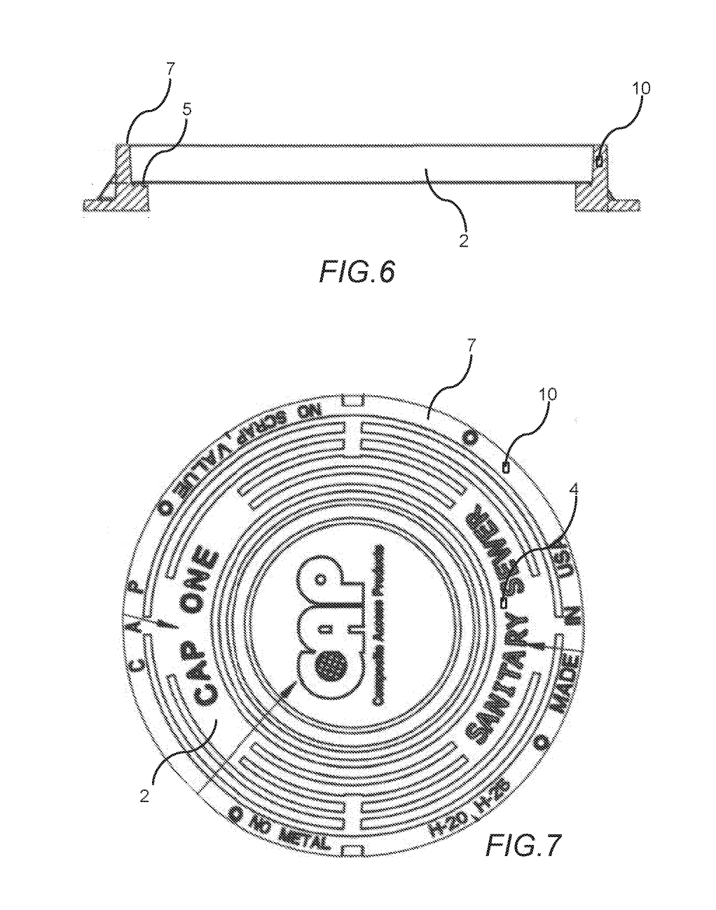

Referring to FIGS. 5-7, views of the composite manhole frame 7 with the electronic/mechanical components 4. Just as the disclosed composite manhole cover 2 includes electronic/mechanical components 4, it is anticipated that, in some embodiments, the composite manhole frame 7, also include electronic/mechanical components 4.

In the examples shown in FIGS. 5-7, an RFID 10 is molded into the composite manhole frame 7, though it is fully anticipated that any electronic/mechanical components 4 be molded into the composite manhole frame 7 such as the electronic device of FIG. 3, having a processor 30. The location of which is anywhere within the frame body of the composite manhole frame 7, as in some embodiments, the electronic/mechanical components 4 is/are located in the wall of the frame body of the composite manhole frame 7.

In some embodiments, the composite manhole frame 7 has a flange 5 on which the composite manhole cover 2 rests.

In FIG. 7, the composite manhole cover 2 is shown installed within the composite manhole frame 7, each having its own electronic/mechanical components 4.

In some embodiments, the electronic/mechanical components 4 are molded into the frame only and not into the composite manhole cover 2.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A composite manhole frame, the composite manhole frame comprising:
a frame body made of a polymer; and
an electronic device having a transmitter;
the electronic device is embedded within the frame, wherein information from the transmitter of the electronic device is readable through the frame.

2. The composite manhole frame of claim 1, wherein the polymer is a thermosetting resin or a mixture of thermosetting resins

3. The composite manhole frame of claim 1, further comprising at least one sensor that is electrically interfaced to the electronic device, the at least one sensor senses a parameter selected from the group consisting of a temperature, a duration of an open state of a composite manhole cover that is held by the composite manhole frame, a duration of a closed state of the composite manhole cover that is held by the composite manhole frame, a presence of hydrogen sulfide gas, and a depth of a fluid beneath the composite manhole cover.

4. The composite manhole frame of claim 1, wherein the polymer is selected from the group consisting of: unsaturated polyester, vinyl ester, and epoxy.

5. The composite manhole frame of claim 1, wherein the polymer includes pigments that provide ultraviolet resistance.

6. The composite manhole frame of claim 1, wherein the composite manhole frame comprises fiberglass blended with the polymer.

7. The composite manhole frame of claim 1, wherein the electronic device is a radio frequency identification device or an RFID.

8. A composite manhole frame comprising:
a frame body, the frame body formed of a polymer; and
at least one electronic component;
the at least one electronic component placed within the polymer prior to curing of the polymer.

9. The composite manhole frame of claim 8, further comprising an insulating coating surrounding the at least one electronic component that is selected from the group consisting of an unsaturated polyester, a vinyl ester, and an epoxy.

10. The composite manhole frame of claim 8, wherein the at least one electronic component comprises a processor, a transceiver, and at least one sensor;
the at least one sensor in communication with the processor and the processor in communication with the transceiver;
wherein the at least one sensor senses data selected from the group consisting of a temperature, a duration of an open state of a manhole cover that is held within the composite manhole frame, a duration of closed state of the manhole cover that is held within the frame, a presence of hydrogen sulfide gas, and a depth of a fluid beneath the manhole cover that is held within the composite manhole frame.

11. The composite manhole frame of claim 8, further comprising a power source embedded within the frame body of the composite manhole frame, the power source for powering the at least one electronic component.

12. The composite manhole frame of claim 8, wherein the at least one electronic component comprises a radio frequency identification device or RFID.

13. The composite manhole frame of claim 8, wherein the polymer is reinforced with fiberglass.

14. The composite manhole frame of claim 8, wherein the polymer is a mixture of one or more materials selected from the group consisting of a polyester resin, a polyurethane, a phenol-formaldehyde resin, urea-formaldehyde, benzoxazines, an epoxy resin, diallyl-phthalate, polyimides, furan, a silicone, and a vinyl ester.

15. A composite polymer manhole frame with embedded electronic components, the composite polymer manhole frame comprising:
a frame body comprising a polymer;
a processor embedded within the frame body;
at least one sensor; and
a transmitter embedded within the frame body;
whereas the at least one sensor is electrically interfaced to the processor for the processor to read data from the at least one sensor and whereas the transmitter is electrically interfaced to the processor for transmitting the data to a remote device.

16. The composite polymer manhole frame of claim 15, wherein the body is formed by molding a mixture of a thermosetting resin, a fiber, and one or more filler compounds.

17. The composite polymer manhole frame of claim 16 wherein the thermosetting resin comprises one or more materials selected from the group consisting of a polyester resin, polyurethanes, phenol-formaldehyde resins, urea-formaldehyde, benzoxazines, an epoxy resin, diallyl-phthalate, polyimides, furan, a silicone, and a vinyl ester.

18. The composite polymer manhole frame of claim 15, wherein:
the frame body further comprises a compatible monomer; and
the polymer is selected from the group consisting of:
unsaturated polyester, vinyl ester, and epoxy;
the compatible monomer is selected from the group consisting of:
styrene, vinyl toluene, daillyl phthalate, and bisphenol A.

19. The composite polymer manhole frame of claim 15, further comprising a power source embedded within the frame body.

20. The composite polymer manhole frame of claim 19, further comprising a solar panel interfaced to the power source for recharging the power source.

21. The composite polymer manhole frame of claim 15, wherein the data is transmitted at regular intervals to the remote device.
